(19) United States
(12) Patent Application Publication
(10) Pub. No.: US 2003/0066136 A1
(43) Pub. Date: Apr. 10, 2003

(54) Pliers for compression connecting a connector for a telephone line

(75) Inventor: Yu-Jung Lu, Tu Cheng City (TW)

Correspondence Address: BACON & THOMAS, PLLC, 625 SLATERS LANE, FOURTH FLOOR, ALEXANDRIA, VA, 22314

(73) Assignee: Hanlong Ind. Co., Ltd, Taipei Hsien (TW)

(21) Appl. No.: 09/970,645

(22) Filed: Oct. 5, 2001

(51) Int. Cl. B25F 1/00

(52) U.S. Cl. 7/107

(57) ABSTRACT

A pair of pliers for compression connecting a connector for a telephone line, the pliers have a compression connecting block connected with a limiting pin inserted in a limiting hole generally of a triangular shape on one handle of the pliers, the upper edge of the limiting hole is an abutting edge bevel relative to a push guiding edge of the limiting hole, when the abutting edge contacts and presses the limiting pin, the contact point between them is located beside the center of the limiting pin toward the direction where an action force directs to. So that the component force of a resisting force from the center of the limiting pin toward the contact point is at the same side as that of the action force. Thereby, the horizontal component force of the action force can be reduced; the abrasion that the horizontal force component may make on the guiding groove can be lowered.

### BACKGROUND OF THE INVENTION

1. Field of the Invention

The present invention is related to a pair of pliers for compression connecting a connector for a telephone line, and especially to a compression connecting structure capable of largely reducing the horizontal component generated by an action force. The pliers can, in addition to obtaining a larger vertical force to connect a connector for a telephone line by compression, largely reduce the damage that the horizontal force component may make on a guiding groove of a compression connecting seat by abrading.

2. Description of the Prior Art

A connector of the communication line of a common communication equipment generally has the coating layer of the communication line peeled off to reveal the core lines a suitable length, and then the core lines are extended into the connector under the inserting pins of the latter in favor that a pair of compression connecting pliers presses the inserting pins of the connector into the connector. The bottoms of the inserting pins pierce the coating layer of the core lines to contact the core lines, and clamp the latter to complete connecting and assembling of the communication line with the connector, And as shown in FIG. 1 which is a schematic view showing a compression connecting structure for assembling a communication line with a connector, wherein, a pair of compression connecting pliers “A” are provided thereon with a pair of handles A1 for holding by an operator, the pair of handles A1 are pivotally connected by a pivot pin A2 at an appropriate position. One of the pair of handles Al is provided thereon with a compression connecting seat A3 for fitting over the connector, while the other of the pair of handles A1 is provided thereon with a compression connecting block A4 for inserting into the compression connecting seat A3 for pressing the connector; so that a compression clamping action of the pair of handles A1 renders the compression connecting block A4 to press fixedly for connecting the connector with the telephone line in the compression connecting seat A3.

The compression connecting seat A3 is provided on the main body thereof with a receiving seat A31 to receive the connector, and with a guiding groove A32 for guiding vertical inserting of the compression connecting block A4. However, by the fact that the handles A1 move in a round path about the pivot pin A2, the compression connecting block A4 is mounted in a limiting groove A6 in one of the handles A1 by means of a limiting pin A5, and the limiting groove A6 is allocated bevelly and away both from the compression connecting seat A3 and the pivot pin A2, so that the lower edge of the limiting groove A6 becomes a push guiding edge A61 to push the compression connecting block A4 away from the receiving seat A31; while the upper edge of the limiting groove A6 becomes an abutting edge A62 to press the compression connecting block A4 into the receiving seat A31. As shown in FIG. 2, when the handles A1 move outwardly, the limiting pin A5 thereof is moved by the push guiding edge A61 of the limiting groove A6 to in turn move the compression connecting block A4 away from the receiving seat A31 of the compression connecting seat A3, so that the connector can be placed into the receiving seat A31, and when the handles Al move inwardly, the limiting pin A5 thereof is moved by the abutting edge A62 on the upper edge of the limiting groove A6 to in turn move the compression connecting block A4 into the receiving seat A31 of the compression connecting seat A3. In this mode, compression connecting of the connector of the telephone line is completed.

And more, the limiting groove of a conventional pair of compression connecting pliers is an elongate slot allocated bevelly, referring to FIGS. 2 and 3, when an operator exert a compressing action force “F” on the handles A1 to render the abutting edge A62 on the upper edge of the limiting groove A6 to press the limiting pin A5 and the compression connecting block A4 for compression connecting, the contact point of the abutting edge A62 with the limiting pin A5 is located beside the center of the limiting pin AS toward the pivot pin A2. The connector in the receiving seat A31 will generate a resisting force “P” by contact of the limiting pin A5 with the connector; and the resisting force “P” may generate a component force PI from the limiting pin A5 toward the contact point of the abutting edge A62 with the limiting pin A5. However, by virtue that the action force “F” for compressing the handles A1 at one side of the pivot pin A2 directs toward the compression connecting seat A3 and the end of the lower handle A1, its component force “P1” is nearly acts in the totally contrary direction to that of the action force “F”; further the action force “F” must form a vertical component force larger than the resisting force “P” under limitation of the guiding groove A32, thereby, the action force “F” will form at the same time a horizontal component force larger than the component force “P1” of the resisting force “P”, Because the vertical component force of the action force “F” is used to press the compression connecting block A4 toward the receiving seat A31, but the horizontal component force of the action force “F” is limited by the lateral edge of the guiding groove A32 from horizontal movement, the horizontal component force of the action force “F” will directly exert on one side of the guiding groove A32 to thereby increase impedance against movement of the compression connecting block A4 in the guiding groove A32, and even to make damage by abrading of the guiding groove A32.

### SUMMARY OF THE INVENTION

Therefore, the pair of pliers for compression connecting a connector for a telephone line of the present invention has a compression connecting block connected with a limiting pin which is inserted in a limiting hole generally of a triangular shape on one of the handles, the upper edge of the limiting hole is an abutting edge bevel relative to a push guiding edges so that when the abutting edge contacts and presses the limiting pin, the contact point between them is located beside the center of the limiting pin toward the direction where the action force directs to. So that the component force of a resisting force from the center of the limiting pin toward the contact point of the abutting edge with the limiting pin is at the same side as that of the action force. Thereby, the horizontal component force of the action force can be reduced, hence a larger vertical force can be obtained for compression connecting the compression connecting connector, thus the abrasion that the horizontal force component may make on the guiding groove can be reduced. And this is the primary object of the present invention.

Another object of the pair of pliers for compression connecting a connector for a telephone line of the present invention is to directly mount a compression connecting seat to straddle the pair of handles and have it fixed on one of the pair of handles, moreover, the main body of the compression connecting seat is provided with an opening for insertion of the other of the pair of handles. A compression connecting block and a compression abutting block are provided respectively on the two sides of one of the handles for compression connecting by opening and closing of the pair of pliers. The handles can be both of a single sheet of a simple structure, cumbersome shaping process can thereby be saved, and the structure as well as the assembling operation of the whole pair of compression connecting pliers can thereby be simplified.

Another object of the pair of pliers for compression connecting a connector for a telephone line of the present invention is to provide fixedly on one of the handles of the pair of pliers a stop plate which has a stopping portion extending to the other of the handles in order to be located in the interspace between the handles when the handles are moved outwardly, thereby, the interspace between the handles provides an obscuring and stopping function to avoid hurt by clamping the fingers of a user extending between the handles. Therefore, the user in using the pair of compression connecting pliers can get an additional guard for protection.

A further object of the pair of pliers for compression connecting a connector for a telephone line of the present invention is to provide an engaging groove at the area where the stop plate extends to the other handle, and to provide at a position in corresponding to the area a moving pin able to extend into the engaging groove. So that when the pair of pliers are not in uses the pliers are pressed to close and then the moving pin is engaged into the engaging groove, thereby the stop plate forms a positioning member between the handles to lock the handles of the pair of pliers in a closed state, and thereby avoids damage by inadvertent pressing the handles to touch a line cutting knife.

The present invention will be apparent after reading the detailed description of the preferred embodiment thereof in reference to the accompanying drawings.

### BRIEF DESCRIPTION OF THE DRAWINGS

FIG. 1 is a schematic view showing the structure of a pair of conventional pliers;

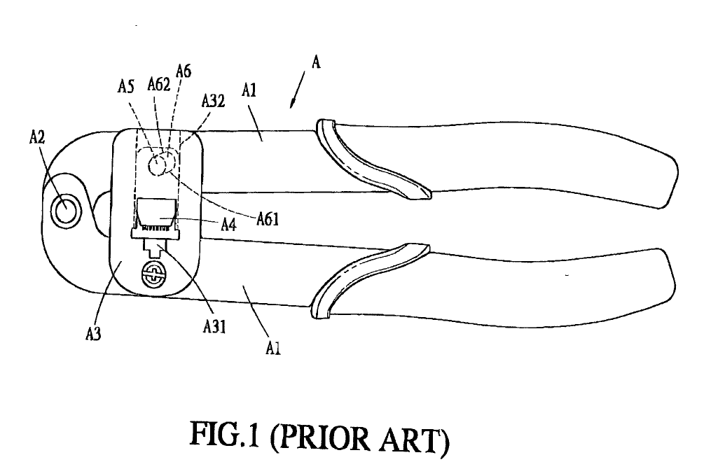

FIG. 2 is a schematic view showing the state of outwardly stretching the handles of the pair of conventional pliers;

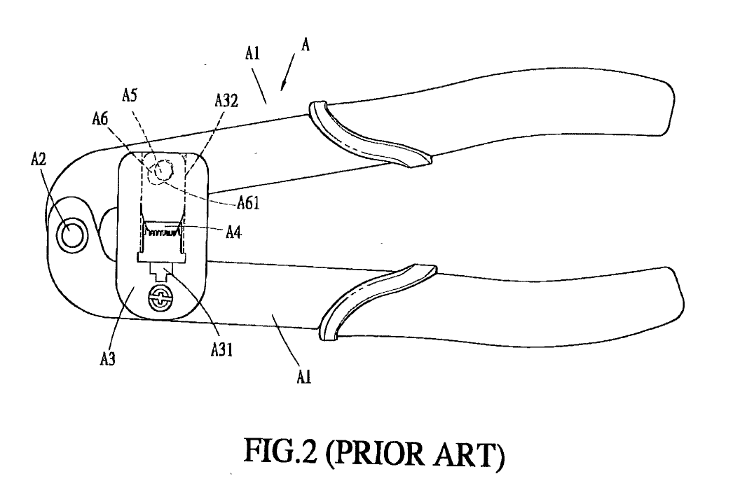

FIG. 3 is a schematic view showing the state of force bearing of a limiting pin when the pair of conventional pliers are pressed to close;

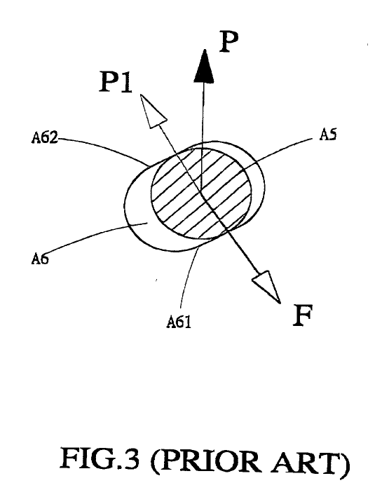

FIG. 4 is a perspective view showing the appearance of a preferred embodiment of the present invention;

FIG. 5 is an analytical perspective view showing the structure of the pair of pliers of the present invention;

FIG. 6 is plane view showing the structure of the pair of compression connecting pliers of the present invention;

FIG. 7 is a schematic view showing the pair of compression connecting pliers of the present invention in the state of outwardly stretching;

FIG. 8 is a schematic view showing fitting in of a connector of the present invention;

FIG. 9 is a schematic view showing the pair of compression connecting pliers of the present invention in the state of pressing to close;

FIG. 10 is a schematic view showing the force bearing state of a limiting pin when the pair of compression connecting pliers of the present invention are pressed to close;

FIG. 11 is a schematic view showing the locking state of the handles of the pair of compression connecting pliers of the present invention.

### DETAILED DESCRIPTION OF THE PREFERRED EMBODIMENT

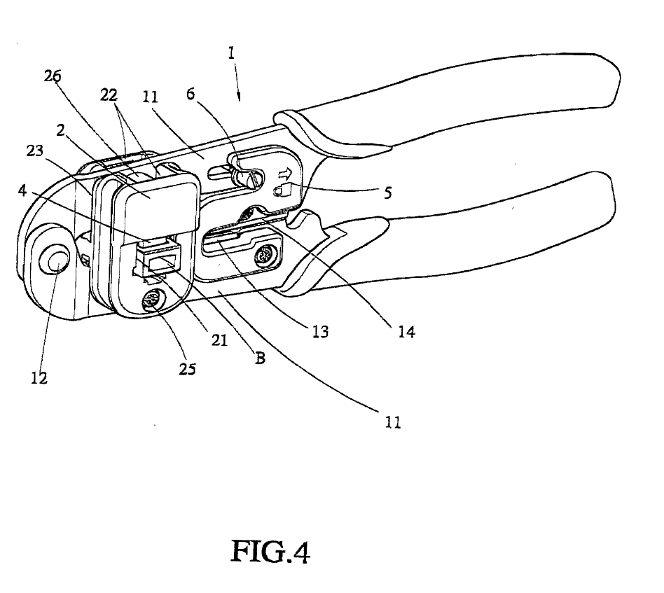

The structure and arrangement of the pair of compression connecting pliers of the present invention are shown in FIG. 4, wherein, the pair of compression connecting pliers 1 basically is comprised of a pair of handles 11 for holding by a user, one end of each of the handles 11 is pivotally connected at a pivot pin 12, and a working section is provided near the joint of the handles 11. Thereby, the working effect can be obtained by compressing and clamping of the handles 11. The working section of the pair of compression connecting pliers 1 includes: a line peeling knife 13, a compression connecting seat 2 for compression connecting inserting pins, and a line cutting knife 14. Thereby, when in assembling of the connector of the communication line, cutting and peeling off of the coating layer of the communication line can be sequentially completed by means of the line cutting knife 14 and the line peeling knife 13, then the compression connecting seat 2 is used to complete compression closing of the connector and the communication line.

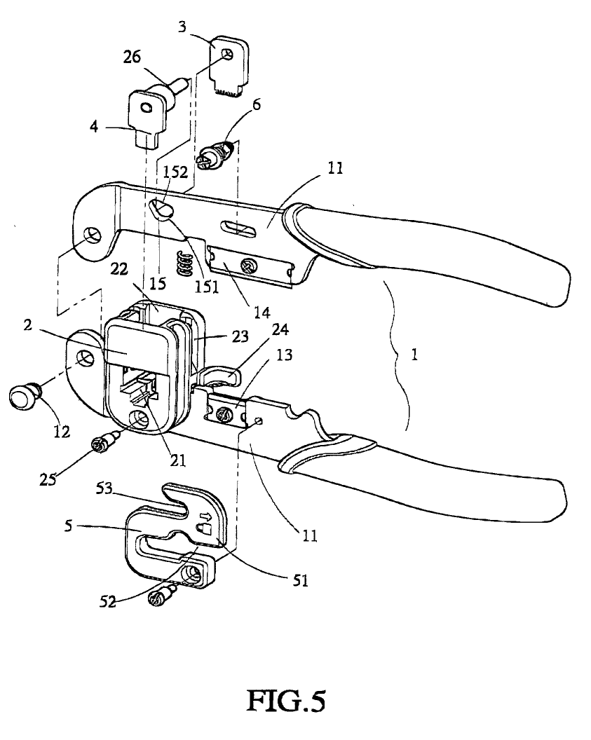

The compression connecting seat 2 is provided directly on one of the pair of handles 11 of the pair of compression connecting pliers 1 and is fixed with an inserting locking member 25. The main body of the compression connecting seat 2 can form thereon a receiving seat 21 to receive the connector “B” of a telephone line and a guiding groove 22 for vertical inserting of the receiving seat 21; and can be provided with an opening 23 for insertion of the other of the pair of handles 11. Referring to FIG. 5 at the same time, the opening 23 is communicated with the guiding groove 22; a compression connecting block 3 and a compression abutting block 4 moving after the opening and closing action of the handles 11 are provided respectively on the two sides of one of the pair of handles 11 and are connected with a limiting pin 26 extended through a limiting hole 15 on the handle 11, they are fitted together in the guiding groove 22. The handles 11 can be both of a single sheet of a simple structures cumbersome shaping process can thereby be saved.

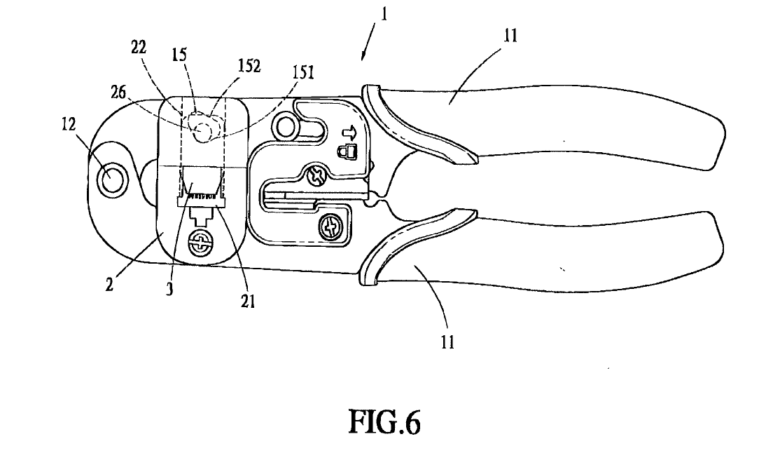

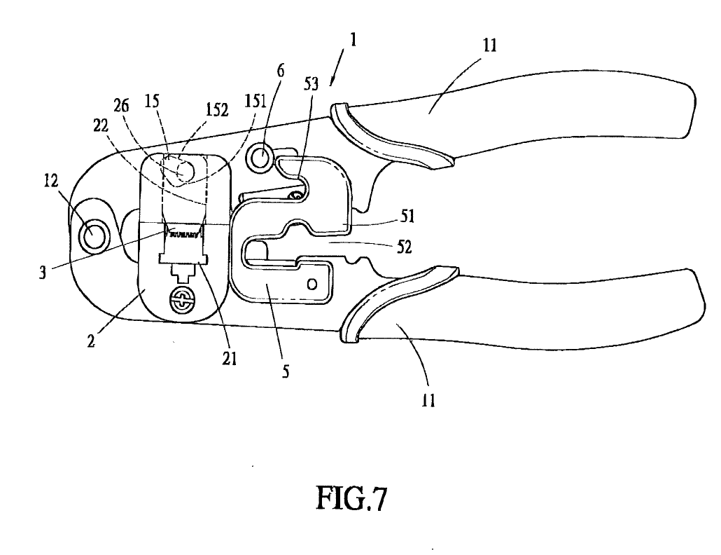

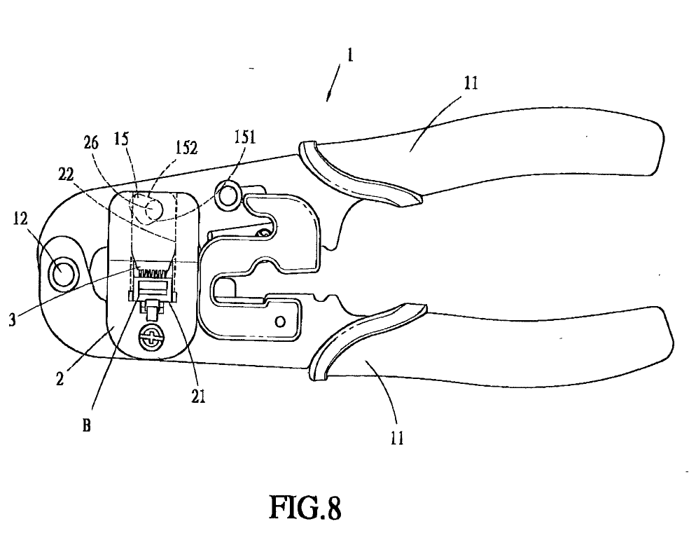

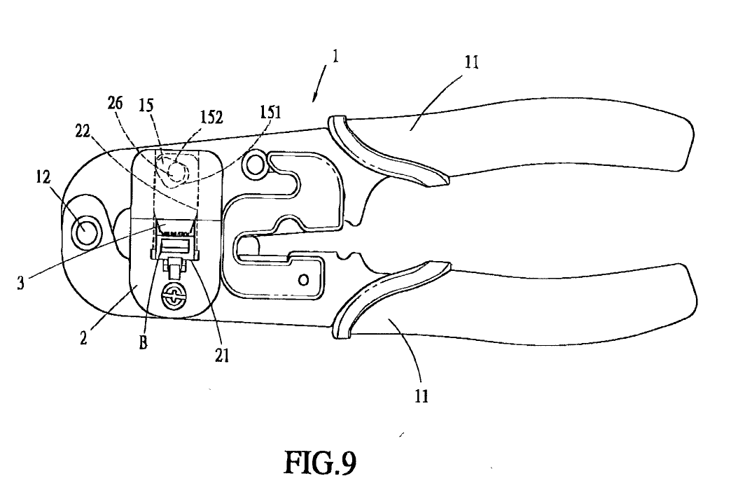

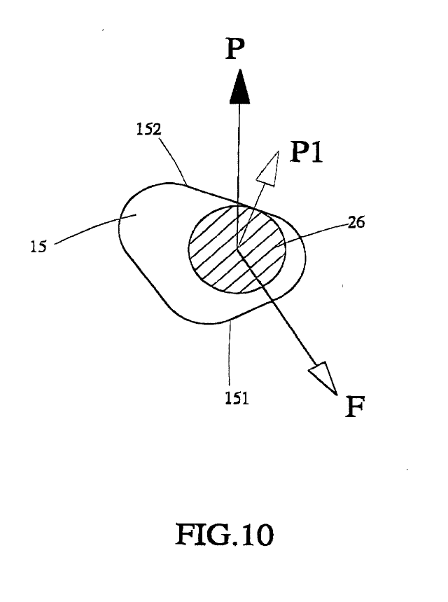

Referring simultaneously to FIGS. 5 and 6, the lower edge of the limiting hole 15 similarly has a bevel push guiding edge 151 provided away from the compression connecting seat 2 and the pivot pin 12. As shown in FIG. 7, when the handles 11 are moved outwardly, the bevel push guiding edge 151 of the limiting hole 15 pushes the limiting pin 26 and in turn the compression connecting block 3 away from the receiving seat 21, so that the connector can be placed into the receiving seat 21 as shown in FIG. 8. Particularly, the upper edge of the limiting hole 15 has an abutting edge 152 slightly bevel relative to the push guiding edge 151, such as is shown in FIGS. 9 and 10, so that when the user exerts an action force “F” to compress the handles 11, the contact point of the abutting edge 152 with the limiting pin 26 is located beside the center of the limiting pin 26 toward the direction where the action force “F” directs to. So that the component force P1 of a resisting force “P” from the center of the limiting pin 26 toward the contact point of the abutting edge 152 with the limiting pin 26 is at the same side as that of the action force “F”. Thereby, the horizontal component force of the action force “F” can be reduced, hence a larger vertical force can be obtained for compression connecting the compression connecting connector “B”, thus the damage that the horizontal force component may make on the guiding groove 22 by abrading can be reduced.

And more, as shown in FIGS. 5 and 7, one of the handles 11 of the pair of compression connecting pliers 1 is provided with a stop plate 5 which has a stopping portion 51 extending to the other of the handles 11. By virtue that the line cutting knife 14 and the line peeling knife 13 both have a sharp blade, the stop plate 5 can directly be allocated at a position where the line cutting knife 14 and the line peeling knife 13 are; and the stop plate 5 proper is provided with a slit 52 for extending of a workpiece into the space between the line cutting knife 14 and the line peeling knife 13, the main body of the stop plate 5 forms a obscuring and protection function from the blades. Besides, a stop piece 24 having specific distances respectively from the blades is formed at the side of the compression connecting seat 2 of the pair of compression connecting pliers 1 neighboring to the line cutting knife 14 and the line peeling knife 13 to form a fast positioning function for a line to be peeled of, and thereby to increase convenience of use of pair of compression connecting pliers 1.

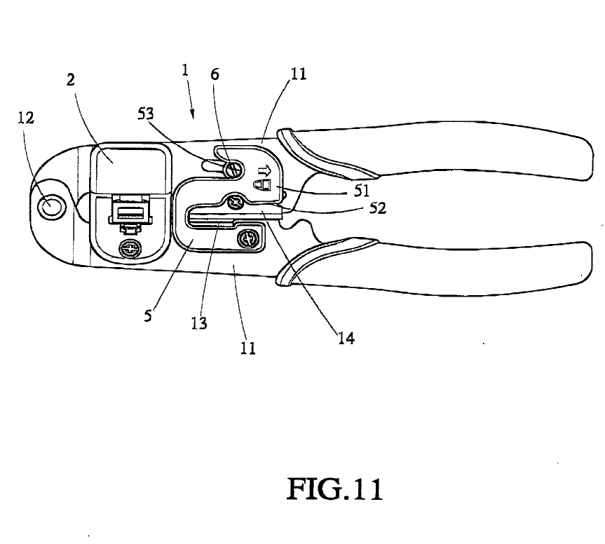

And when the stop plate 5 is provided on the portion thereof extending to the aforesaid other handle 11 with an engaging groove 53, and to provide at a position in corresponding to this portion of the other handle 11 a moving pin 6 able to extend into the engaging groove 53. So that when the pair of pliers 1 are not in use as shown in FIG. 11, the pliers 1 are pressed to close and then the moving pin 6 is engaged into the engaging groove 53, thereby the stop plate 5 forms a positioning member between the handles 11 of the pair of pliers 1 to lock the handles 11 in a closed state, and thereby avoids damage by inadvertent pressing the handles to touch the line cutting knife 14.

The pair of pliers 1 for compression connecting the connector “B” for a telephone line of the present invention has the compression connecting block 3 connected with the limiting pin 26 which is inserted in the limiting hole 15 generally of a triangular shape on one of the handles 11, the upper edge of the limiting hole 15 is the abutting edge 152 bevel relative to the push guiding edge 151; so that when the abutting edge 152 contacts and presses the limiting pin 26, the contact point between them is located beside the center of the limiting pin 26 toward the direction where the action force “F” directs to. So that the component force P1 of a resisting force “P” from the center of the limiting pin 26 toward the contact point of the abutting edge 152 with the limiting pin 26 is at the same side as that of the action force “F”. Thereby, the horizontal component force of the action force “F” can be reduced, hence a larger vertical force can be obtained for compression connecting the compression connecting connector “B”, thus the damage that the horizontal force component may make on the guiding groove 22 by abrading can be reduced. In this way, a better structure of the pair of compression connecting pliers 1 is provided.

Having thus described my invention, what I claim as new and desire to be secured by Letters Patent of the United States are:

1. A pair of pliers for compression connecting a connector for a. telephone line, said pair of compression connecting pliers is comprised of a pair of handles for holding by a user, a working section is provided near the joint of said handles, thereby, a working effect is obtained by compressing and clamping said handles; wherein, said working section has a compression connecting seat fixedly mounted on one of said handles, the other of said handles is mounted thereon with a compression connecting block, said compression connecting seat is provided on the main body thereof with a receiving seat to receive said connector, and with a guiding groove for guiding vertical inserting of said compression connecting block, said compression connecting block is connected with a limiting pin which is inserted in a limiting hole in said other handle, and said limiting hole is allocated bevelly and away both from said compression connecting seat and said pivot pin, so that the lower edge of said limiting hole is used to push said compression connecting block away from said receiving seat; said pliers are characterized by:
said limiting hole is Generally of a triangular shape, the upper edge of said limiting hole is an abutting edge bevel relative to a push guiding edge thereof; so that when said abutting edge contacts and presses said limiting pin, the contact point between them is located beside the center of said limiting pin toward the direction where an action force directs to, thereby, the component force of a resisting force from said center of said limiting pin toward said contact point of said abutting edge with said limiting pin is at the same side as that of said action force; thereby, the horizontal component force of said action force is reduced, and a larger vertical force is obtained for compression connecting said compression connecting connector, thus the abrasion that said horizontal force component may make on said guiding groove is reduced.

2. A pair of pliers for compression connecting a connector for a telephone line as defined in claim 1, wherein,
a compression connecting scat is directly mounted to straddle said pair of handles and is fixed on said one of said pair of handles, moreover, said main body of said compression connecting seat is provided with an opening for insertion of said other handle; said compression connecting block and a compression abutting block are provided respectively on the two sides of said other handle for compression connecting by opening and closing of said pair of pliers, said handles are both of a single sheet of a simple structure, cumbersome shaping process can thereby be saved, and the Structure as well as the assembling operation of said pair of compression connecting pliers is thereby simplified.

3. A pair of pliers for compression connecting a connector for a telephone line as defined in claim 1, wherein,
said one of said pair of handles is fixedly provided with a stop plate which has a stopping portion extending to said other handle in order to be located in the interspace between said handles when said handles are moved outwardly, thereby, said interspace between said handles provides an obscuring and stopping function to avoid hurt by clamping fingers of a user extending between said handles, therefore, the user in using said pair of compression connecting pliers gets an additional guard for protection.

4. A pair of pliers for compression connecting a connector for a telephone line as defined in claim 3, wherein,
an engaging groove is provided at the area where said stop plate extends to said other handle, and a moving pin able to extend into said engaging groove is provided at a position in corresponding to said area, so that when said pair of pliers are not in use, said pliers are pressed to close and then said moving pin is engaged into said engaging groove, thereby said stop plate forms a positioning member between said handles to lock said handles of said pair of pliers in a closed state.

5. A pair of pliers for compression connecting a connector for a telephone line as defined in claim 1, wherein,
said pliers are provided with a line peeling knife and a line cutting knife.

6. A pair of pliers for compression connecting a connector for a telephone line as defined in claim 1, wherein,
a stop piece having specific distances respectively from the blades of said line cutting knife and said line peeling knife is formed at the side of said compression connecting seat neighboring to said line cutting knife and said line peeling knife to form a fast positioning function for a line to be peeled off, and thereby to increase convenience of use of said pair of compression connecting pliers.
